(19) United States
(12) Patent Application Publication
(10) Pub. No.: US 2026/0288944 A1
(43) Pub. Date: Sep. 24, 2026

(54) DATA PRESERVATION VIA OUT-OF-BAND SECURITY MANAGEMENT

(71) Applicant: Dell Products L.P., Round Rock, TX (US)

(72) Inventors: PHANINDRA BHARGAV TALASILA, Georgetown, TX (US); IBRAHIM SAYYED, Georgetown, TX (US); ADOLFO SANDOR MONTERO, Pflugerville, TX (US); XIAOMEI ZHU MILLER, Round Rock, TX (US)

(21) Appl. No.: 19/085,636

(22) Filed: Mar. 20, 2025

(51) Int. Cl. G06F 21/55; G06F 21/56; G06F 21/57

(52) U.S. Cl. CPC G06F 21/554; G06F 21/566; G06F 21/575; G06F 2221/034

(57) ABSTRACT

Methods and systems for managing operation of a data processing system are disclosed. To do so, an out-of-band component of the data processing may make an identification of a potential malicious attack on data stored in a storage device of hardware resources of the data processing system and by an entity hosted by the hardware resources via an in-band channel to the storage device. Based on the identification a management controller may perform, via at least one side band channel, a remediation process to attempt to mitigate impacts of the potential malicious attack on the data to facilitate continued provision of computer implemented services using the data.

### FIELD

Embodiments disclosed herein relate generally to managing operation of data processing systems. More particularly, embodiments disclosed herein relate to managing data and/or file security across a distributed system for data processing systems potentially subjected to malicious attacks.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIGS. 1A-1C show diagrams illustrating a system in accordance with an embodiment.

FIGS. 2A-2B show interaction diagrams in accordance with an embodiment.

FIG. 3 shows a flow diagram illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary de vices, such as in a network topology.

In general, embodiments disclosed herein relate to methods and systems for managing operation of a data processing system within a distributed environment that may include any number of data processing systems. The (any number of) data processing systems may provide computer-implemented services to any type and/or number of other devices and/or users of the data processing systems. The computer-implemented services may include any quantity and type of such services.

To provide the computer-implemented services, the data processing systems may each include any number of hardware components whose respective operations may facilitate various functionalities of the data processing systems. For example, any one of the data processing systems may include any number of storage devices for storing data and allowing future access to this stored data by processes performed by the any one of the data processing systems.

For example, an authorized user of one of the data processing systems may store a number of professional and/or personal documents and media files on a non-volatile memory express (NVMe) storage device while this NVMe storage device is operably connected to the (one) data processing system. The user may then continue to access these professional and/or personal documents and media files for any number of reasons not to be limited by embodiments discussed herein. This continued access may be made possible due to the allocation of physical storage space of the NVMe storage device for the professional and/or personal documents and media files to be recorded/committed to.

However, assume that this NVMe storage device is subjected to a ransomware attack that attempts to exploit the user's professional and/or personal data by holding said data hostage (e.g., via encryption of the entirety of the data processing system's files of data) to then demand ransom should the user desire access to the (their own) professional and/or personal data. Should such a ransomware attack occur, not only may the user's data now be at the mercy of an unknown entity's exploitation, but the distributed system in which the data processing system is a part may be negatively impacted, thereby increasing a likelihood of negatively impacting the computer implemented services that any portion of the distributed system may provide.

Consequently, such a ransomware attack may involve malicious processes already associated with “signatures” (e.g., file-level and/or system-level patterns of activity) of a certain type in their wake. For example, a malicious process adapted to perform the aforementioned encryption may facilitate a series of input/output (I/O) requests that share a strong resemblance with I/O patterns resulting from previously observed and/or otherwise known performance of such malicious processes.

Therefore, a management controller of the data processing system and/or a controller of the NVMe storage device may collaborate via out-of-band communication channels of the data processing system to detect such I/O patterns that share the strong resemblance. Such collaboration may be followed by a remedial process that continues to utilize advantages provided by the out-of-band communication channels. Such advantages may include, for example, the out-of-band channels being isolated from (and therefore saved from) interference via in-band communication channels that may be at the mercy of, and therefore be vulnerable to, the ransomware attack. Should the collaborative detection conclude early enough during the ransomware attack, the remedial process may include successfully mitigating negative impacts on operation of the NVMe storage device, operation of the data processing system, operation of the distributed system, and/or the (providing of the) computer implemented services.

Thus, embodiments disclosed herein may provide a method for managing, by one or more out-of-band components, operation of a data processing system by utilizing sideband (e.g., out-of-band) communication channels to detect (e.g., infer) a likely high-risk event that poses a threat to data stored on an NVMe storage device of the data processing system. This detection (e.g., inferred to be a high-risk event) may then, for example, be used to manage operation of the NVMe storage device specifically. By doing so, a likelihood of data stored on the NVMe storage device being used in an unauthorized manner (such as without the user's knowledge and/or with disregard for the user's privacy and/or autonomy) may be decreased. Additionally, based on the amount of time it takes to perform and complete the remedial process, (i) the sooner performance of the remedial process is completed during the malicious process, the more data/files of data that may be preserved (e.g., saved) from being held ransom. In contrast, the longer it takes to perform and complete the remedial process, the more data/files of data that may be lost/encrypted to then be held for ransom.

In an embodiment, a method for managing operation of a data processing system is provided.

The method may include making, by an out-of-band component of the data processing system, an identification of a potential malicious attack on data stored in a storage device of hardware resources of the data processing system and by an entity hosted by the hardware resources via an in-band channel to the storage device; and based on the identification, performing, by a management controller and via at least one sideband channel, a remediation process to attempt to mitigate impacts of the potential malicious attack on the data to facilitate continued provision of computer implemented services using the data.

The out-of-band component may be one selected from a group consisting of the management controller and a controller of the storage device.

The controller of the storage device may be adapted to load firmware during a boot of the data processing system, the firmware defining operation of the storage device during the making of the identification and the performing of the remediation process.

The entity may be malware hosted by a processor of the hardware resources, and the potential malicious attack may be an encryption-based attack on the data.

The making the identification may include monitoring, via a first sideband channel between the management controller and the storage device, input-output to the storage device for occurrences of predetermined input-output patterns; and in an instance of the monitoring where the input-output matches one of the predetermined input-output patterns, concluding that an occurrence of the potential malicious attack has occurred.

The predetermined input-output patterns may include a recursive reading pattern for directories and files stored in the directories.

The performing of the remediation process may include locking the storage device from use by the hardware resources.

The performing of the remediation process may further include initiating, by the management controller, a confirmation process for confirmation that the potential malicious attack is an actual malicious attack.

The performing of the remediation process may further include, in an instance of the initiating of the confirmation process in which the potential malicious attack is confirmed to be the actual malicious attack, performing at least one action based on feedback from an entity that confirmed the actual malicious attack.

The performing of the remediation process may further include performing an alert process to mitigate impacts of operation of the entity on other components of a distributed system of which the data processing system is a member.

The management controller may operate independently from and may be distinct from the hardware resources.

The management controller may be on a separate power domain from the hardware resources so that the management controller may be operable while the hardware resources are inoperable.

In an embodiment, a non-transitory media is provided. The non-transitory media may include instructions that when executed by a processor cause the computer-implemented method to be performed.

In an embodiment, a system is provided. The system may include the non-transitory media and a processor and may perform the computer-implemented method when the computer instructions are executed by the processor.

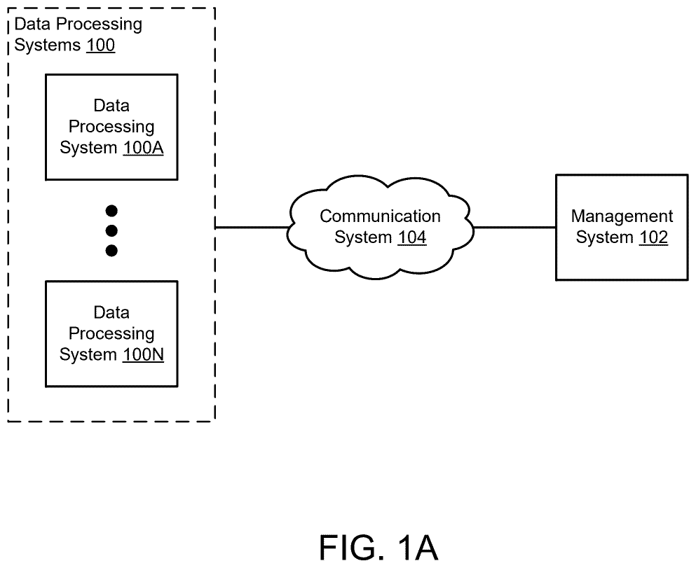

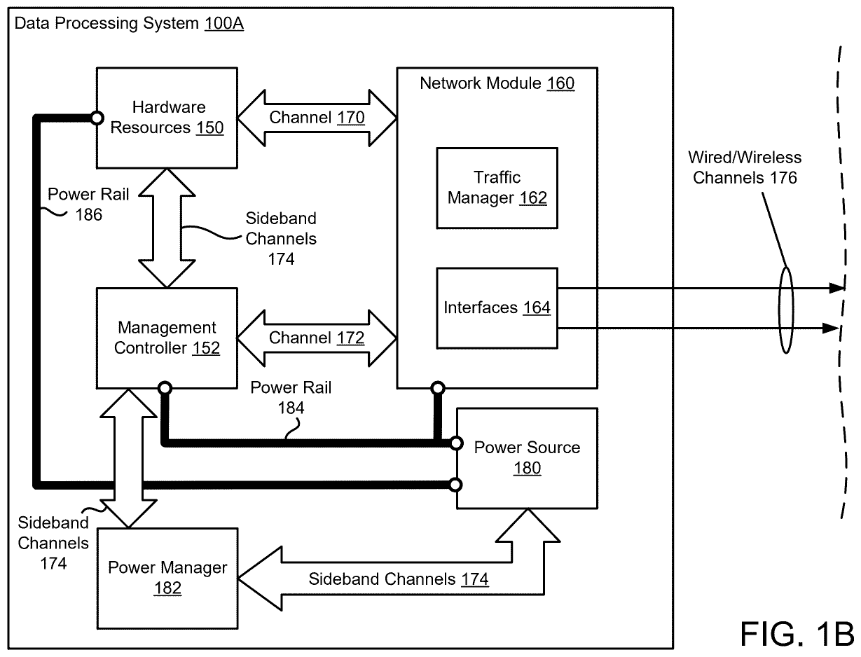

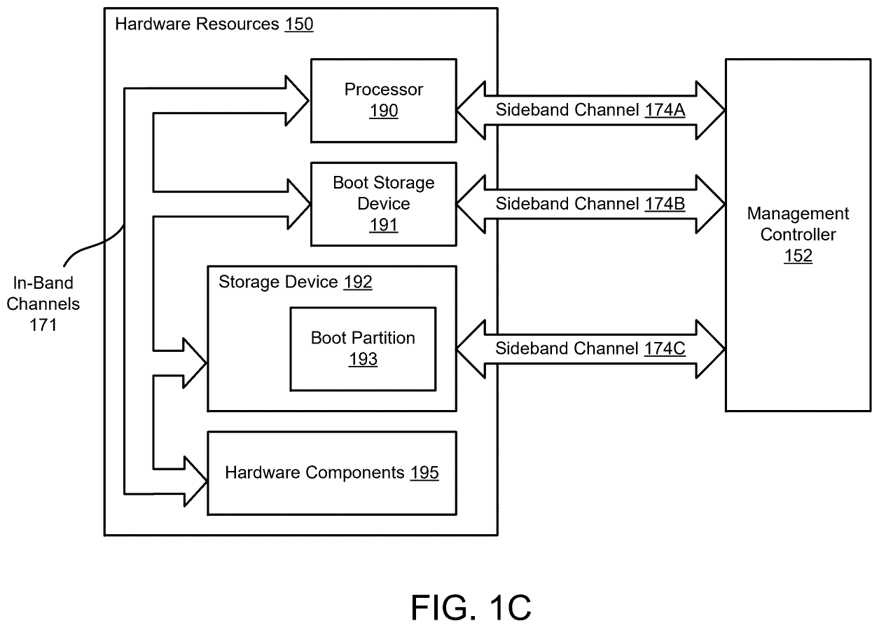

Turning to FIG. 1A, a block diagram illustrating a system in accordance with an embodiment is shown. The system shown in FIG. 1A may provide for management of data processing systems that may provide, at least in part, computer-implemented services (e.g., to a user of the system and/or devices operably connected to the system).

The system may include any number of data processing systems 100 (e.g., computing devices) that may each include any number of hardware components (e.g., processors, memory modules, storage devices, communication devices, etc.). The hardware components may support execution of any number and types of applications (e.g., software components). Changes in available functionalities of the hardware and/or software components may provide for various types of different computer-implemented services to be provided over time.

For additional details regarding data processing systems 100, refer to FIG. 1B discussed further below.

The computer-implemented services may include any type and quantity of computer-implemented services. The computer-implemented services may include, for example, database services, data processing services, electronic communication services, and/or any other services that may be provided using one or more computing devices. The computer-implemented services may be provided by, for example, data processing systems 100, management system 102, and/or any other type of devices (not shown in FIG. 1A). Other types of computer-implemented services may be provided by the system shown in FIG. 1A without departing from embodiments disclosed herein.

The computer-implemented services may be provided at least in part, by hardware resources of data processing systems 100. To provide the computer-implemented services, a data processing system may perform a booting process to initialize operation of the hardware resources. To do so, a processor (e.g., a central programming unit (CPU)) of the hardware resources may utilize boot data (e.g., basic input/output system (BIOS) firmware, system configuration files, etc.) that may be stored on a boot storage device. The boot storage device may include, for example, a non-volatile memory storage device (e.g., serial peripheral interface flash).

By performing the booting process, the hardware resources of the data processing system may be operably connected to each other (e.g., via in-band communication channels) and an operating system may be loaded to provide management functionalities.

Additionally, this operating system (OS) may utilize a file storage system whose storage may be physically allocated to, for example, cells on a non-volatile memory express (NVMe) storage device. By allocating such files of digital data to these cells, the files may be respectively stored at physical addresses on the NVMe storage device that may each be respectively associated with a digital (e.g., logical) address. For example, various directories/indexes may include associations between the digital and physical addresses respectively with one another.

Therefore, (hardware and/or software) components that may depend on information stored in any one file from the files may request said file from the OS, the OS using the associations from the directories/indexes to read (e.g., obtain) the one file from storage.

Such files may be assumed to belong to a user (an authorized user) of the data processing system. For example, such files may include professional and/or personal information/data that may be privy to the user. Therefore, it may be further assumed that the user may initiate performance of various processes involving management of said files. Such interaction from the user to initiate such processes may be facilitated by software components such as a service client (e.g., a client adapted to display popup windows containing information for the user and that may take input from the user via any number of interactive elements to determine how operation of the data processing system may continue).

To facilitate operation of the data processing system, the OS and/or the service client may therefore be programs that run post-boot. For example, running programs such as the OS and the service client may be hosted by a processor (e.g., the central processing unit (CPU)) of the data processing system, and may utilize the in-band communication channels to facilitate operation of the data processing system. For example, this processor of the data processing system may perform (e.g., during boot) functionalities for a booting process that include taking inventory of any and all operably connected devices (e.g., via the in-band communication channels).

However, assume that, for example, the data processing system has been compromised by a malicious program (e.g., malware) that, once having successfully compromised the data processing system, may attempt to facilitate a ransomware attack.

For example, if under a malicious program's control (e.g., the malware being hosted by the processor and running alongside, for example, the OS and/or the service client), any number of security features and/or configurations of the data processing system may be bypassed, deprecated, etc. Consequently, communications that may be intercepted and/or otherwise perverted by the malicious program via in-band channels during management of connected devices may result in at least a portion of the hardware resource's inoperability and/or may otherwise negatively impact provisioning of the computer implemented services as expected and/or desired by, for example, the user.

Consequently, such a malicious program as this malware may facilitate and/or otherwise initiate performance of processes already associated with “signatures” (e.g., file-level and/or system-level patterns of activity) of a certain type in their wake. For example, a malicious process adapted to perform the aforementioned encryption may facilitate a series of input/output (I/O) requests that share a strong resemblance with I/O patterns resulting from performance of such malicious processes.

In general, embodiments disclosed herein relate to systems, devices, and methods for managing operation of a data processing system. To modify the operation of the data processing system in an event of compromise (e.g., due to a ransomware attack) and/or reduced functionality of the at least a portion of the hardware resources, the data processing system may host a management controller that may operate independently from the hardware resources and may be distinct from, and adapted to manage, the hardware resources. For example, the management controller may operate during the booting process regardless of an outcome of the booting process performed by booting components (e.g., the boot storage device and/or the processor) of the hardware resources. Similarly, the management controller may be capable of communication with any number of devices via out-of-band communication channels during the management of connected devices, thereby avoiding interference from the malicious program while the management controller facilitates its own operation.

Therefore, to further manage the operation of a data processing system, the management controller may collaborate with a controller of the storage device to detect such I/O patterns that share the strong resemblance via out-of-band communication channels of the data processing system.

Such collaboration may be followed by a remedial process that continues to utilize advantages provided by the out-of-band communication channels. Such advantages may include, for example, the out-of-band channels being isolated from (and therefore saved from) interference via in-band communication channels that may be at the mercy of the ransomware attack. Should the collaborative detection conclude early enough during the ransomware attack, the remedial process may include successfully mitigating negative impacts on operation of the NVMe storage device, operation of the data processing system, operation of the distributed system, and/or the (providing of the) computer implemented services.

Thus, embodiments disclosed herein may provide a method for managing, by one or more out-of-band components, operation of a data processing system by utilizing sideband (e.g., out-of-band) communication channels to detect (e.g., infer) a likely high-risk event that poses a threat to data stored on an NVMe storage device of the data processing system. This detection (e.g., inferred to be a high-risk event) may then, for example, be used to manage operation of the NVMe storage device specifically. By doing so, a likelihood of data stored on the NVMe storage device being used in an unauthorized manner (such as without the user's knowledge and/or with disregard for the user's privacy and/or autonomy) may be decreased.

To provide the above noted functionality, the system may include data processing systems 100, and management system 102. Each of these components is discussed below.

Data processing systems 100 may include any number of data processing systems (e.g., 100A-100N) that may individually and/or cooperatively provide at least a portion of the computer-implemented services. Any of data processing systems 100 may include in-band components (e.g., hardware resources), out-of-band components (e.g., management controller, network modules, etc.), and functionality that may allow the out-of-band components to communicate with management system 102 via an out-of-band communication channel.

While providing the computer-implemented services, a data processing system (e.g., 100A) of data processing systems 100 may communicate with and/or obtain information from management system 102. For example, data processing system 100A may communicate to management system 102 that there has been a confirmed risk of malicious processes negatively impacting operation of data processing system 100A. Management system 102 may, for example, be adapted to manage each of data processing systems 100 while performing other administrative duties and/or troubleshooting any occurrence of challenges for the distributed system.

Such a confirmed risk as mentioned above may be indicative of malware having breached data processing system 100A's security, and therefore, similar risk to the entire distributed system may have an increased likelihood of taking place (e.g., occurring). Thus, management system 102 may isolate data processing system 100A in such a manner as to quarantine data processing system 100A from the rest of data processing systems 100. By doing so, data processing system 100A may be triaged based on the malicious program's operation without compromising any of the rest of data processing systems 100.

Any of data processing systems 100 may thereby obtain updated firmware for implementing an out-of-band detection process, management requests to modify operation of the hardware resources (e.g., installing new applications), and/or any other information. Data processing system 100A may subsequently perform actions based on the information obtained from management system 102 to update operation of data processing system 100A and/or cutoff potential malware from breaching the other data processing systems within the distributed system.

Management system 102 may, as discussed above, provide remote management services. Management system 102 may include, for example, a second data processing system operated by an owner of data processing systems 100 (e.g., the user). To provide the remote management services, management system 102 may interact with data processing systems 100 to obtain and/or provide information (e.g., data) relevant to operation of data processing systems 100.

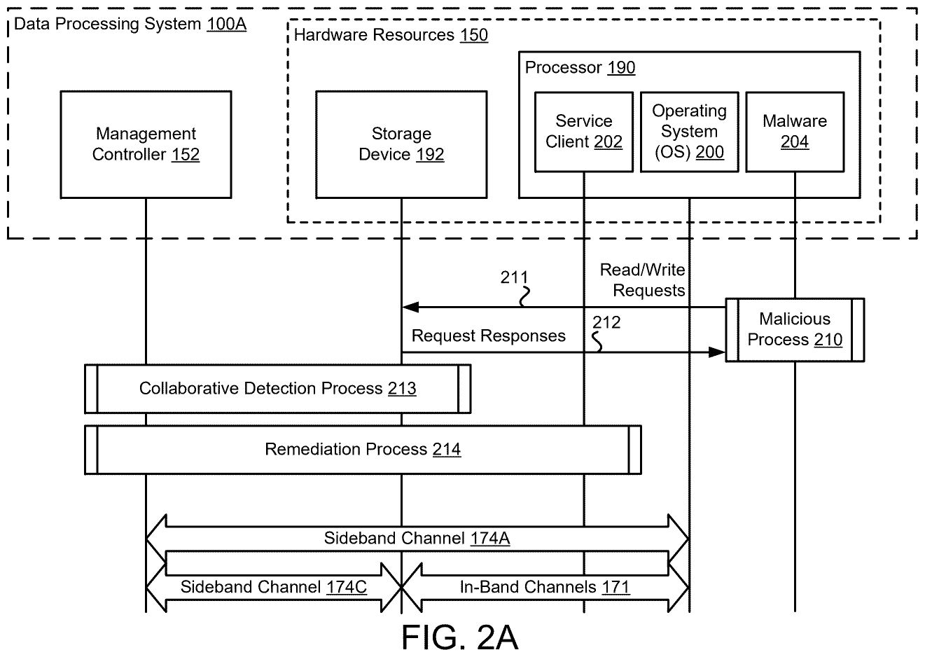

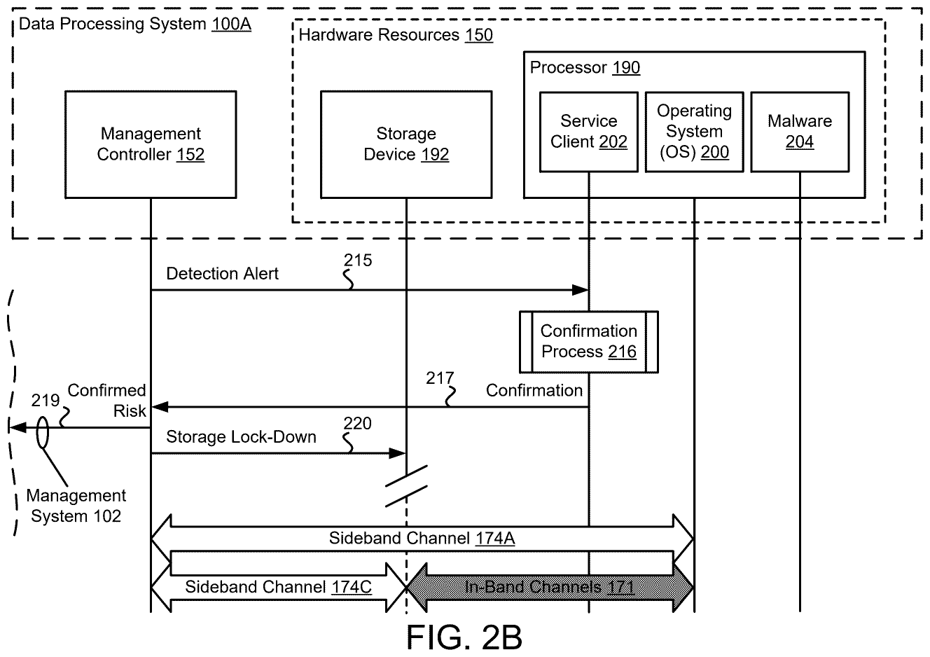

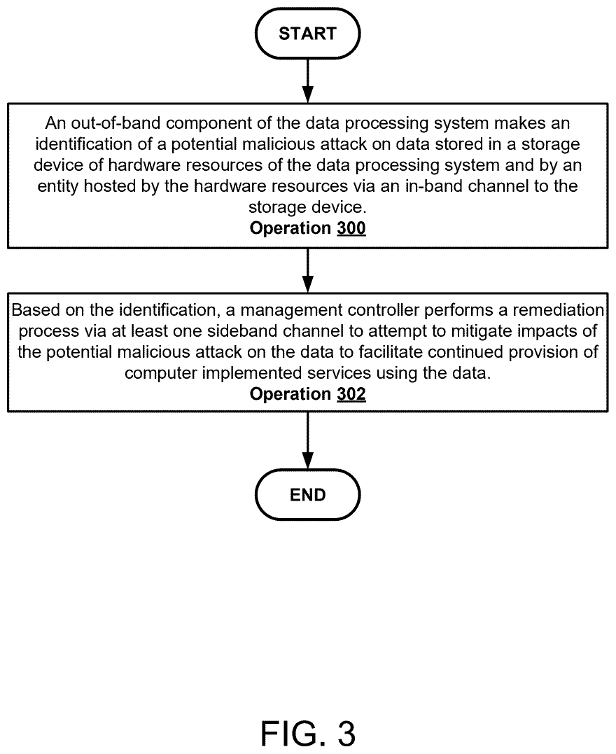

While providing their functionality, any of data processing systems 100, and/or management system 102 may provide all or a portion of the methods shown in FIGS. 2A-3.

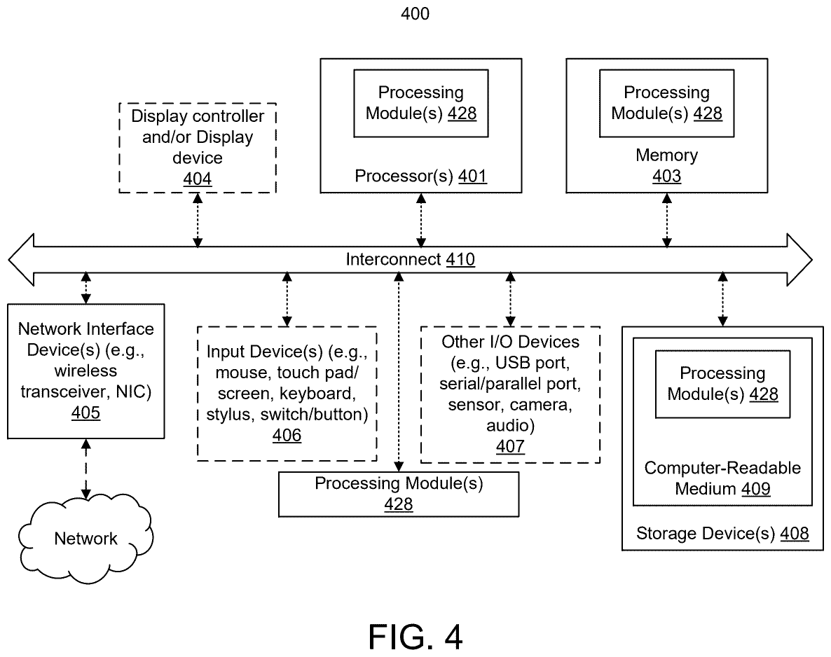

Communication system 104 may allow any of data processing systems 100, and/or management system 102 to communicate with one another (and/or with other devices not illustrated in FIG. 1A). To provide its functionality, communication system 104 may be implemented with one or more wired and/or wireless networks. Any of these networks may be a radio access network (e.g., a cellular core network), a private network (e.g., the “Network” shown in FIG. 4), a public network, and/or may include the Internet. For example, data processing systems 100 may be operably connected to management system 102 via the Internet. Data processing systems 100, management system 102, and/or communication system 104 may be adapted to perform one or more protocols for communicating via communication system 104.

Any of (and/or components thereof) data processing systems 100, and management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Thus, as shown in FIG. 1A, a system in accordance with an embodiment may manage operation of a data processing system by detecting I/O patterns sharing strong resemblance to malicious patterns and attempting remediation from there in an attempt to mitigate the negative impacts that may be caused by, for example, the ransomware attack.

While illustrated in FIG. 1A with a limited number of specific components, a system may include additional, fewer, and/or different components without departing from embodiments disclosed herein.

Turning to FIG. 1B, a diagram illustrating a data processing system (e.g., 100A in FIG. 1A) in accordance with an embodiment is shown. As shown in FIG. 1B, data processing system 100A may be similar to any of the data processing systems shown in FIG. 1A.

To provide computer-implemented services, data processing system 100A may include any quantity of hardware resources 150. Hardware resources 150 may be in-band hardware components, and may include a processor operably coupled to memory, storage, and/or other hardware components.

The storage may include any number and/or types of storage devices (e.g., hard drives, solid state drives, etc.). A storage device of the storage devices may include, for example, (i) memory (e.g., non-volatile memory), (ii) a controller that may manage data operations (e.g., storage, retrieval, organization, etc.), and/or (iii) other physical components. The storage device may support storage protocols (e.g., non-volatile memory express) that may facilitate use of storage resources of the storage device.

For example, the storage may include a first storage device adapted to host an image of a startup management entity (e.g., basic input/output system (BIOS)), system configurations, and/or any other information. Additionally, the storage may include a second storage device that may include, but not be limited to, storage for information necessary to boot the data processing system, load an operating system for the data processing system, and/or perform any other processes.

The processor may host various management entities such as operating systems, drivers, network stacks, and/or other software entities that provide various management functionalities. For example, the operating system and drivers may provide abstracted access to various hardware resources.

To facilitate communication, hardware resources 150 may host a network stack that may facilitate packaging, transmission, routing, and/or other functions with respect to exchanging data with other devices. For example, the network stack may support transmission control protocol/internet protocol communication (TCP/IP) (e.g., the Internet protocol suite) thereby allowing hardware resources 150 to communicate with other devices via packet switched networks and/or other types of communication networks.

The processor may also host various applications that provide the computer-implemented services. The applications may utilize various services provided by the management entities and use (at least indirectly) the network stack to communication with other entities.

However, utilization of the network stack and the services provided by the management entities may place the applications at risk of indirect compromise. For example, if any of these entities trusted by the applications are compromised, these entities may subsequently compromise the operation of the applications. Additionally, if various drivers and/or the communication stack are compromised, communications to/from other devices may be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 100A) to another device via any number of intermediate networks (e.g., via wired/wireless channels 176 that are part of the networks).

To reduce the likelihood of the applications and/or other in-band entities from being indirectly compromised, data processing system 140 may include management controller 152 and network module 160. Each of these components of data processing system 140 is discussed below.

Management controller 152 may be implemented, for example, using a system on a chip or other type of independently operating computing device (e.g., independent from the in-band components, such as hardware resources 150 of a host data processing system 100A).

Management controller 152 may provide various management functionalities for data processing system 100A. For example, management controller 152 may monitor various ongoing processes performed by the in-band components, may manage power distribution, thermal management, and/or other functions of data processing system 100A.

To provide the management functionalities, management controller 152 may utilize data that may, at least temporarily be stored on storage resources hosted by management controller 152. For example, management controller may download an image of a new management entity (e.g., firmware, application, etc.) in response to a management request, store the image, and install the new management entity using at least the image on hardware resources 150.

Because an ability of management controller 152 to provide the management functionalities may be limited when the data exceeds storage capacity of storage resources hosted by the management controller, management controller 152 may utilize any number and/or types of storage devices hosted by hardware resources 150.

To do so, management controller 152 may be operably connected to various components via sideband channels 174 (in FIG. 1B, a limited number of side band channels are included for illustrative purposes, it will be appreciated that management controller 152 may communication with other components via any number of side band channels). The side band channels may be implemented using separate physical channels, and/or with a logical channel overlay over existing physical channels (e.g., logical division of in-band channels). The side band channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, management controller 152 may communicate information relevant to identifying a boot status of data processing system 100A, storing data to a boot partition of a storage device of hardware resources 150, restoring boot data hosted by a boot storage device, initiating a rebooting processing, and/or performing any other actions.

Management controller 152 may be operably connected to communication components of data processing system 100A via separate channels (e.g., 172) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted components may not result in indirect compromise of management controller 152 and any entities hosted by management controller 152.

For example, storage devices of hardware resources 150 may not be operably connected to a processor (e.g., due to in-band channels between the processor and the storage devices not being functional during the booting process). Management controller 152 may communicate with the processor and the storage device via sideband channels 174. By doing so, management controller 152 may perform management functionalities (e.g., detecting I/O patterns indicative of a malicious attack on the system) or detecting a system hang during booting, obtaining data from a storage device, restoring boot data on the boot storage device, etc.) regardless of an operating state of hardware resources 150.

To facilitate communication with other devices, data processing system 100A may include network module 160. Network module 160 may provide communication services for in-band components and out-of-band components (e.g., management controller 152) of data processing system. To do so, network module 160 may include traffic manager 162 and interfaces 164.

Traffic manager 162 may include functionality to (i) discriminate traffic directed to various network endpoints advertised by data processing system 100A, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a WiFi card, a wireless local area network card, a wired local area network card, an optical communication card, and/or other types of communication components. These components may support any number of wired/wireless channels 176.

Thus, from the perspective of an external device, the in-band components and out-of-band components of data processing system 100A may appear to be two independent network entities, which may be independently addressable, and otherwise unrelated to one another.

To facilitate management of data processing system 100A over time, hardware resources 150, management controller 152 and/or network module 160 may be positioned in separately controllable power domains. By being positioned in these separately controllable power domains, different subsets of these components may remain powered while other subsets are unpowered.

For example, management controller 152 and network module 160 may remain powered while hardware resources 150 is unpowered. Consequently, management controller 152 may remain able to communication with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, data processing system 100A may include a power source (e.g., 180) that separately supplies power to power rails (e.g., 184, 186) that power the respective power domains. Power from the power source (e.g., a power supply, battery, etc.) may be selectively provided to the separate power rails to selectively power the different power domains. A power manager (e.g., 182) may manage power from power source 180 that is supplied to the power rails. Management controller 152 may cooperate with power manager 182 to manage supply of power to these power domains.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

When providing its functionality, management controller 152 may perform all, or a portion, of the methods and operations illustrated in FIGS. 2A-3B.

While illustrated in FIG. 1B with a limited number of specific components, a system may include additional, fewer, and/or different components without departing from embodiments disclosed herein.

Turning to FIG. 1C, to provide computer-implemented services, hardware resources 150 may host processor 190, boot storage device 191, and storage device 192. For example, to place a data processing system (e.g., 100A) in a desired operating state, data processing system 100A may perform a booting process to initialize hardware resources and facilitate operation of an operating system. To do so, processor 190 may execute instructions indicated by boot data (e.g., firmware, system configuration, etc.) hosted by boot storage device 191.

Boot storage device 191 may include, for example, non-volatile flash memory (e.g., serial peripheral interface (SPI) flash) that may be hosted on a motherboard and adapted to store information, such as firmware, an image of a management entity (BIOS, universal extensible firmware interface (UEFI), etc.), system configuration files, and/or any other information usable to boot data processing system 100A. Because boot storage device 191 may have a limited storage capacity, storage device 192 may be used to store additional information (e.g., other copies of boot data and/or files of other types of data).

Storage device 192 may include, for example, a second storage device such as a non-volatile memory express (NVMe) based solid-state drive. Storage device 192 may include a boot partition (193) that may be configured to store data usable to boot data processing system 100A (e.g., the latest stable copy of boot data, bootloader files, configuration files, etc.). Boot partition 193 may include an allocated section of storage device 192 that may, for example, be isolated from other memory sections of storage device 192.

Processor 190 may include a central processing unit (CPU) that may interact with any number and/or type of other hardware components (e.g., boot storage device 191, storage device 192, and hardware components 195). For example, when data processing system 100A is powered on, processor 190 may be initialized to a predetermined state and directed to retrieve instructions (e.g., via a reset vector) from boot storage device 191. To interact with boot storage device 191, storage device 192, and/or the other hardware components, processor 190 may be operably connected to each of the components via in-band channels 171.

However, at least a portion of in-band channels 171 may not be functional and/or may have reduced functionality during booting of data processing system 100A and/or as a result of an undesired boot event. For example, in an event that storage device 192 and/or hardware components 195 are not initialized during booting, processor 190 may not be able to communicate with storage device 192 to obtain a copy of boot data (e.g., a backup copy, a recovery file, etc.) for use in rebooting and placing data processing system 100A in a desired operating state.

Thus, to improve a likelihood that data processing system 100A may be booted and placed in the desired operating state, management controller 152 may perform management functionalities using any number and/or type of sideband channels (e.g., 174). For example, management controller may obtain information (e.g., telemetry data, process results, boot times, etc.) regarding a boot status from processor 190 using sideband channel 174A, replace a copy of undesired boot data hosted by boot storage device 191 with a latest stable copy of boot data using sideband channel 174B, read and/or write boot data to boot partition 193 of storage device 192 using sideband channel 174C, and/or perform any other actions by communicating with components of hardware resources regardless of a boot status of data processing system 100A.

To further clarify embodiments disclosed herein, interaction diagrams in accordance with an embodiment are shown in FIGS. 2A-2B. The interaction diagrams may illustrate how data may be obtained and used within the system of FIGS. 1A-1C.

To further clarify embodiments disclosed herein, interaction diagrams in accordance with an embodiment are shown in FIGS. 2A-2B. The interaction diagrams may illustrate how data may be obtained and used within the system of FIGS. 1A-1C.

In the interaction diagrams, processes performed by and interactions between components of a system in accordance with an embodiment are shown. In the diagrams, components of the system are illustrated using a first set of shapes (e.g., 152, 192, 190, 202, etc.), located towards the top of each figure. Lines descend from these shapes. Processes performed by the components of the system are illustrated using a second set of shapes (e.g., 210, 213, 214, etc.) superimposed over these lines. Interactions (e.g., communication, data transmissions, etc.) between the components of the system are illustrated using a third set of shapes (e.g., 211, 212, etc.) that extend between the lines. The third set of shapes may include lines terminating in one or two arrows. Lines terminating in a single arrow may indicate that one-way interactions (e.g., data transmission from a first component to a second component) occur, while lines terminating in two arrows may indicate that multi-way interactions (e.g., data transmission between two components) occur. Out-of-band and in-band communication channels (e.g., sideband channels) that operably connect various components of the system with one another are illustrated using a fourth set of shapes (e.g., 174A, 174C, and 171) that extend between the lines. The fourth set of shapes may include large double ended arrows that indicate use of a sideband channel between two of the components.

The processes and interactions are temporally ordered in an example order, with time increasing from the top to the bottom of each page. For example, the interaction labeled as 212 may occur prior to the process labeled as 213. However, it will be appreciated that the processes and interactions may be performed in different orders, any may be omitted, and other processes or interactions may be performed without departing from embodiments disclosed herein.

The lines descending from some of the first set of shapes (e.g., 152, 192, 190, 202, etc.) are drawn in dashing to indicate, for example, that the corresponding components may not be (i) operable, (ii) powered on, (iii) present in the system, and/or (iv) not participating in operation of the system for other reasons. (e.g., not being utilized by, for example, a management controller using an out-of-band communication channel). This dashing may alternate back to the original solid (e.g., non-dashed) characteristic of the descending lines and vice versa any number of times.

The change between the original solid and the dashing as the lines descend may be marked by diagonal, yet parallel with regard to one another, lines that cut the descending lines as they change. Such marked cuts along the descending lines are drawn to indicate, for example, moments of change where a processor (e.g., 190) may utilize respective in-band communication channels to (i) interact with various components of a (potentially compromised) data processing system, or (ii) cease interaction with any of the various components.

It will also be appreciated that utilization of out-of-band communication channels may be facilitated for security purposes. For example, and generally, a processor of the data processing system may perform functionalities for a booting process that include taking inventory of any and all operably connected devices. However, under a preventative assumption in which the data processing system may be assumed to be otherwise compromised. For example, if in a malicious entity's control, any number of security features and/or configurations of the system may be bypassed, deprecated, etc. Consequently, communications that may be intercepted and/or otherwise perverted via in-band channels during management of connected devices may instead be isolated when via sideband channels that prevent such interference.

Turning to FIG. 2A, a first interaction diagram in accordance with an embodiment is shown. The first interaction diagram may illustrate processes and interactions that may occur during management of a data processing system's operation during, for example, a ransomware attack on the data processing system.

For example, to prompt such management of data processing system 100A, malware 204 may be permitted, via some deceptive means, to be hosted by processor 190. For example, an authorized user of data processing system 100A may absentmindedly click on an email attachment that is sent from an unfamiliar, external (outside the user's company network) email address. By clicking on this email attachment, assume the user has inadvertently given permission for software such as malware 204 to run on data processing system 100A, the permission allowing malware 204 to utilize in-band communication channels between components to negatively affect operation of data processing system 100A. Such permission may allow performance of, for example, malicious process 210, as shown in FIG. 2A.

During malicious process 210, malware 204 may take advantage of this permission to control/influence certain aspects of operating system (OS) 200 also hosted by processor 190, as well as to utilize, uninhibited, the in-band communication channels of data processing system 100A (e.g., 171).

For example, malware 204 may attempt to encrypt the files of data stored on storage device 192 using an encryption key that is only known to a malicious actor responsible for malware 204's operation. In doing so, the malicious actor makes it incredibly difficult to decrypt the files without the key, making it unlikely that the files, once encrypted, may ever be decrypted without an associated decryption key. The malicious actor may then wait for the entirety of storage device 192's stored files to be encrypted before contacting the authorized user to offer a trade in which the user may be pressured to pay a ransom (e.g., a large sum) in exchange for the decryption key.

Thus, during malicious process 210, interactions such as 211 and 212 may be facilitated by OS 200 as specified by malware 204, such interactions being performed repetitively/recursively. For example, at interaction 211, malware 204 may initiate any number of read/write requests to (a controller of) storage device 192. For example, malware 204 may request information regarding what files are stored in a C:// drive of data processing system 100A.

At interaction 212, the requested information may be provided to malware 204. Malware 204 may then, again, initiate interaction 211. For example, this second iteration of interaction 211 may include requests for some range of files from the C: // drive, this range of files being provided for malware 204 during a second iteration of interaction 212. Consequently, once provided any file of data from these files, malware 204 may facilitate generation of an encrypted version of the file using the encryption key. Malware 204 may then initiate a third iteration of interaction 211 during which the encrypted version of the file is written over the original (non-encrypted) version of the file.

Consequently, the original (non-encrypted) version may thus be replaced by the encrypted version, the original (non-encrypted) version becoming lost and/or otherwise unattainable moving forward. For example, this generation of encrypted versions of the files and their use to replace their respective original (non-encrypted) versions may continue until the entirety of files stored on storage device 192 are replaced by encrypted versions of said files.

However, such a pattern resulting from these repetitive read/write requests, this pattern being observable due to, for example, a firmware of storage device 192 adapted to do so, may share strong resemblance to any number of Input/Output (I/O) patterns associated with potential malicious attacks such as this example ransomware attack via malware 204.

Any detection of such a strong resemblance may therefore be possible, for example, due to collaborative detection process 213.

During collaborative detection process 213, monitoring (by some means) of activity regarding storage device 192 may be performed by management controller 152 and/or the controller of storage device 192 to obtain resulting activity patterns that may or may not match a pattern associated with a potential malicious attack (e.g., may or may not have a strong resemblance to patterns associated with malicious attacks indicated by a degree of similarity that is above a similarity threshold).

For example, the controller of storage device 192 may pass along copies of the read/write requests over to management controller 152 via an out-of-band (e.g., sideband) communication channel. The management controller may then generate I/O patterns based on the copies of the read/write requests.

Once these I/O patterns have been obtained, they may be subjected to any type and/or quantity of similarity analysis by management controller 152 and/or the controller of storage device 192. During this analysis, and based on the previously mentioned similarity threshold, any I/O pattern shown to have a strong resemblance to a pattern associated with a potential malicious attack may be flagged (e.g., marked, labeled, etc.) and inferred (e.g., concluded) by management controller 152 and/or the controller of storage device 192 to be indicative of a potential malicious attack having occurred and/or that is ongoing (e.g., the I/O pattern inferred to be a malicious pattern).

Therefore, during collaborative detection process 213, an I/O pattern may be inferred to be a malicious pattern indicative of an occurrence the ransomware attack involving malware 204 that is facilitating an ongoing malicious process to encrypt the entirety of files stored on storage device 192. Such a conclusion (e.g., inference) regarding the I/O pattern may trigger performance of remediation process 214 during which an attempt to mitigate negative impacts cause by such a potential malicious attack may be made via a collaboration of out-of-band communications between, for example, management controller 152, the controller of storage device 192, and/or service client 202 that may be hosted (similar to OS 200 and malware 204) by processor 190.

For additional information regarding remediation process 214, refer to the discussion of FIG. 2B below.

It will be appreciated that in some cases, it may be concluded (as a result of collaborative detection process 213) that there is no occurrence of a malicious process. In such cases, a remediation process may be unnecessary, and therefore, may not be performed as discussed below.

Turning to FIG. 2B, a second interaction diagram in accordance with an embodiment is shown. The second interaction diagram may illustrate processes and interactions that may occur during management of a data processing system's operation during, for example, a ransomware attack on the data processing system. More specifically, FIG. 2B may be discussed with regard to remediation process 214 in FIG. 2A, the following discussion of FIG. 2B being used to expand on sub-processes included in the performance of remediation process 214.

For example, and as previously discussed, remediation process 214 may be performed in an attempt to mitigate an impact that malicious process 210 may have on the operation of data processing system 100A. Such an attempt may be based, for example, on an I/O pattern inferred to be a malicious pattern.

For example, once this maliciousness is inferred, collaborative detection process 213 may be concluded (e.g., ended, at least temporarily), followed by performance of remediation process 214. Therefore, for example, to manage operation of data processing system 100A, remediation process 214 may be performed based on detection of the I/O pattern sharing the strong resemblance.

During remediation process 214, for example, management controller 152 and/or the controller of storage device 192 may interact (e.g., at interaction 215) with service client 202.

For example, at interaction 215, a detection alert may be provided via sideband channel 174A to service client 202 to inform (e.g., via a digital user interface (UI)) an authorized user of data processing system 100A of the conclusion that some malicious process is likely happening and/or has likely happened.

Additionally, the detection alert may include text/other data indicating that additional information may be desirable to better manage security of storage device 192, data processing system 100A, and the rest of the distributed system (e.g., from FIG. 1A). For example, such other data may include (i) a request confirmation that such a malicious process is not, in actuality, the authorized user's doing, and/or (ii) a request, from the authorized user, input regarding what management actions may be desirable to perform to mitigate the previously mentioned impact. Once service client 202 obtains the detection alert, service client 202 may initiate confirmation process 216.

During confirmation process 216, a check may be performed using information from the detection alert provided at interaction 215 to ascertain whether the I/O pattern sharing the strong resemblance with the malicious pattern is a result of activity purposefully facilitated by the authorized user, or whether the authorized user is not intentionally causing such activity to generate the I/O pattern in question.

For example, based on interaction 215, service client 202 may provide the authorized user with a visual display on a monitor (e.g., peripheral accessory of data processing system 100A) belonging to the authorized user, the visual display including, for example, a pop-up window. This pop-up window may otherwise include text that serves as an alert for the user that there is suspicious I/O activity being detected and that may need attention. The pop-up window may include, for example, interaction elements (e.g., buttons) that the authorized user may interact with to provide feedback to data processing system 100A regarding the suspicious I/O activity.

For example, the text from the pop-up window may further include a questions like “ . . . was this suspicious I/O activity you?” and underneath the text, the pop-up window may include buttons labeled as “no” and “yes,” respectively. The authorized user may then, assuming the suspicious I/O activity is not familiar to the authorized user, click the button labeled “no,” thereby concluding (in some cases) confirmation process 216.

Such provided feedback as clicking the “no” button may be considered as confirmation of some kind that may then be provided to management controller 152. By “confirmation”, it will be appreciated that the feedback provided by the authorized user may either (i) confirm that the suspicious I/O activity is indeed malicious or (ii) confirm that the suspicious I/O activity is a justly intended series of operations and not to be prevented by out-of-band security management processes.

Therefore, at interaction 217, confirmation may be obtained by management controller 152 that the suspicious I/O activity is indeed malicious and should be managed to mitigate negative impacts from such malicious processes (e.g., 210).

Based on interaction 217, management controller 152 may initiate performance of management actions to mitigate impact on operation of data processing system 100A and operation of any other devices in the distributed system by, for example, malicious process 210. Such management actions may include, for example, (i) interaction 219 and/or (ii) interaction 220.

At interaction 219, for example, management controller 152 may interact with management system 102 (discussed with regard to FIG. 1A) to provide management system 102 with a confirmed risk to data processing system 100A.

As previously discussed, management system 102 may manage any number of data processing systems (e.g., any of data processing systems 100) within the distributed system of FIG. 1A. As part of this functionality, management system 102 may isolate a device from other devices in the distributed system if the device is likely compromised (or has any risk of compromise). Such isolation may be implemented with (i) disconnection of the likely compromised device from the rest of data processing systems 100, (ii) automatic shutdown of the likely compromised device (e.g., to perform maintenance during follow-up management, the shutdown serving as another form of disconnection from the distributed system), (iii) wipe the likely compromised device of all files of data locally stored on the likely compromised device, including configuration settings for communication between the likely compromised device and the rest of the distributed system (thereby facilitating unfamiliarity between the likely compromised device and the rest of the distributed system so previous trust used to previously facilitate communication with the likely compromised device may not be maintained, and thus, may be forgotten with trust needing to be reestablished), and/or (iv) other management actions may be attempted to prevent the negative impacts on the rest of data processing systems 100 by malicious processes (e.g., 210) performed at the expense of the likely compromised device (e.g., data processing system 100A).

At interaction 220, management controller 152 may interact with the controller of storage device 192 to initiate, for example, provisioning of storage lock-down instructions to the controller of storage device 192, that when abided by the controller. may otherwise cause in-band communications with storage device 192 to be severed and/or prevented. Such lockdowns of storage devices may be maintained until otherwise instructed by management controller 152, management system 102, the authorized user, and/or any other entity/system holding a higher-level system management authority than that of management controller 152.

To indicate successful performance of the storage lockdown based on interaction 220, in-band channels 171 is depicted with patterned in-fill to appear shaded, and thus, representative of downed communications via in-band channels 171.

Thus, using processes and interactions shown in FIGS. 2A-2B, a controller of an NVMe storage device and/or a management controller (both being out-of-band components of a data processing system) may perform a collaborative detection of I/O patterns known to result from performance of known malicious processes. Such detection may then be used to perform remediations for potential occurrences of such malicious attacks via, for example, management of the NVMe storage device's operation and/or the data processing system's operation. By doing so, a likelihood of data stored on the storage device being used in an unauthorized manner (such as without a user's (to whom the data stored on the storage device is likely associated/belonging to) knowledge, consent, and/or autonomous regard) may be decreased.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1A-1C may perform various methods to manage (e.g., manage operation of) a data processing system. FIG. 3 illustrates a method that may be performed by the components of the (distributed) system previously discussed with regard to FIGS. 1A-1C. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing operation of a data processing system in accordance with an embodiment is shown. The method may be performed, for example, by any of the components of the (distributed) system shown in FIGS. 1A-1C (e.g., management controller 152 and/or the controller of storage device 192), and/or other components not to be limited by embodiments disclosed herein.

At operation 300, an out-of-band component of the data processing system makes an identification of a potential malicious attack on data stored in a storage device of hardware resources of the data processing system and by an entity hosted by the hardware resources via an in-band channel to the storage device. The out-of-band component may make the identification of the potential malicious attack by, for example, (i) monitoring, via a first sideband channel between the management controller and the storage device, input-output to the storage device for occurrences of predetermined input-output patterns, and (ii) in an instance of the monitoring where the input-output matches one of the predetermined input-output patterns, concluding that an occurrence of the potential malicious attack has occurred, and/or (iii) other processes not to be limited by embodiments discussed herein may be performed.

The out-of-band component may be one selected from a group consisting of (i) the management controller and (ii) a controller of the storage device. This may be the case due to the management controller and the controller being capable to, and adapted to specifically, facilitate secure communication with one another in a manner that is unable to be interfered with by the entity. Such interference may be unable to occur due to the channels used for this secure communication; channels such as the first sideband channel.

Similarly, it will be appreciated that the management controller may respectively share an out-of-band communication channel for each component of a various amount of components of the data processing system. Due to the channel infrastructure surrounding functionality of the management controller, the management controller may serve as an anchor for uncompromised operation of the data processing system. To do so, the management controller may operate independently from, and may be distinct from, the hardware resources. Additionally, for example, the management controller may be on a separate power domain from the hardware resources so that the management controller may be operable while the hardware resources are inoperable.

In order for the controller of the storage device to collaborate with the management controller to monitor, compare, and match I/O patterns with one another based on ongoing I/O to the storage device, the controller may be implemented with firmware adapted to do so. For example, the controller of the storage device may be adapted to load such firmware during a boot of the data processing system, the firmware, once loaded, defining operation of the storage device during the making of the identification and during a performing of a remediation process (discussed further below). The predetermined input-output patterns may include a recursive reading pattern for directories and files stored in the directories.

The reason for such compromise of the in-band communications of the data processing system by the entity may be due to the entity being capable of infecting communications between the processor and other components of the data processing system. To do so, for example, the entity may be malware hosted by the processor of the hardware resources, and the potential malicious attack may be, for example, an encryption-based attack on the data.

For example, assume the same example as that discussed with regard to malicious process 210 in FIGS. 2A-2B. As previously discussed, the malware (e.g., 204) may take advantage of a permission it was (e.g., unintentionally) granted to utilize the in-band communication channels of the data processing system. Using the in-band channels, the malware may initiate read/write requests in a particular way to the storage device to, for example, systematically encrypt the entirety of the data stored by the data processing system.

The controller of the storage device, based on its firmware, may monitor I/O to the storage device as the I/O are performed to obtain any number of I/O patterns to be compared to predetermined I/O patterns (e.g., predetermined based on past observations, the predetermined I/O patterns being likely of I/O activity results from malicious processes.

For example, this I/O activity may be provided to the management controller. Once obtained, the management controller may organize and/or otherwise process the I/O activity, the controller of the storage device and the management controller collaborating to perform similarity analyses between I/O patterns obtained based on the observed activity of data processing system 100A and each of the predetermined I/O patterns.

It will be appreciated that when performing the similarity analysis, that a similarity threshold may be used to define when a degree of similarity between two patterns reaches significant similarity (e.g., such that, for example, they may appear to be duplicates and/or result from extremely similar, if not same, processes).

For example, assume that I/O patterns sharing 80% similarity with one another may be likely to have similar, if not same, processes performed that resulted in the similar I/O patterns. Therefore, assume, for example, that 80% was our similarity threshold, and that we observed an I/O pattern that matches within that 80% threshold, thereby indicating an I/O pattern of activity resulting from processes inferred to be malicious. This inference may serve as the identification of the potential malicious attack.

At operation 302, based on the identification, a management controller performs a remediation process via at least one sideband channel to attempt to mitigate impacts of the potential malicious attack on the data to facilitate continued provision of computer implemented services using the data. The management controller may, via the at least one sideband channel, perform the remediation process by, for example, (i) initiating, by the management controller, a confirmation process for confirmation that the potential malicious attack is an actual malicious attack, (ii) performing an alert process to mitigate impacts of operation of the entity on other components of a distributed system of which the data processing system is a member, (iii) locking the storage device from use by the hardware resources, and/or (iv) other processes not to be limited by embodiments discussed herein may be performed.

It will be appreciated that the remediation process may be performed as described with regard to FIGS. 2A-2B. For additional detail regarding the remediation process, refer back to FIGS. 2A-2B.

For example, as discussed previously with regard to FIGS. 2A-2B, performing the remediation process may further include, in an instance of the initiating of the confirmation process in which the potential malicious attack is confirmed to be the actual malicious attack, performing at least one action based on feedback from an entity that confirmed the actual malicious attack. The at least one action may include, for example, alerting a maintenance team that data processing system 100A is likely compromised, and thus, may be properly quarantined until the ransomware attack threat has been remedied. The at least one action may include, for example, instructing the controller of the storage device to lock-down the storage device from being accessed/communicated with via the in-band communication channels, thereby preventing further manipulation of the storage device and the data the storage device stores by the malware (the entity). Additional actions may also be performed such as getting rid of the malware hosted by the processor now that there is largely prevented risk of the ransomware attack worsening its impact on the data processing system.

By performing the method illustrated and described with regard to FIG. 3, a distributed system may include any number of data processing systems that have an increased likelihood of preserving data by utilizing out-of-band communication channels when the systems perceive a threat to data allocated to physical hard drive space. In doing so, a likelihood of the distributed system providing computer implemented services as expected and/or desired may be increased.

The method may end following operation 302.

Thus, a method of managing operation of a data processing system in accordance with an embodiment is shown.

Any of the processes and/or components illustrated in and/or discussed with regard to FIGS. 1A-3 may be implemented with and/or used in conjunction with one or more computing devices.

Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data processing system, the method comprising:
making, by an out-of-band component of the data processing system, an identification of a potential malicious attack on data stored in a storage device of hardware resources of the data processing system and by an entity hosted by the hardware resources via an in-band channel to the storage device; and
based on the identification:
performing, by a management controller and via at least one side band channel, a remediation process to attempt to mitigate impacts of the potential malicious attack on the data to facilitate continued provision of computer implemented services using the data.

2. The method of claim 1, wherein the out-of-band component is one selected from a group consisting of the management controller and a controller of the storage device.

3. The method of claim 2, wherein the controller of the storage device is adapted to load firmware during a boot of the data processing system, the firmware, once loaded, defining operation of the storage device during the making of the identification and the performing of the remediation process.

4. The method of claim 1, wherein the entity is malware hosted by a processor of the hardware resources, and the potential malicious attack is an encryption-based attack on the data.

5. The method of claim 1, wherein making the identification comprises:
monitoring, via a first sideband channel between the management controller and the storage device, input-output to the storage device for occurrences of predetermined input-output patterns; and
in an instance of the monitoring where the input-output matches one of the predetermined input-output patterns:
concluding that an occurrence of the potential malicious attack has occurred.

6. The method of claim 5, wherein the predetermined input-output patterns comprise a recursive reading pattern for directories and files stored in the directories.

7. The method of claim 1, wherein performing the remediation process comprises:
locking the storage device from use by the hardware resources.

8. The method of claim 1, wherein performing the remediation process comprises:
initiating, by the management controller, a confirmation process for confirmation that the potential malicious attack is an actual malicious attack.

9. The method of claim 8, wherein performing the remediation process further comprises:
in an instance of the initiating of the confirmation process in which the potential malicious attack is confirmed to be the actual malicious attack:
performing at least one action based on feedback from an entity that confirmed the actual malicious attack.

10. The method of claim 1, wherein performing the remediation process comprises:
performing an alert process to mitigate impacts of operation of the entity on other components of a distributed system of which the data processing system is a member.

11. The method of claim 1, wherein the management controller operates independently from and is distinct from the hardware resources.

12. The method of claim 11, wherein the management controller is on a separate power domain from the hardware resources so that the management controller is operable while the hardware resources are inoperable.

13. A non-transitory machine-readable medium having instructions stored therein, which when executed by a processor, cause the processor to perform operations for managing operation of a data processing system, the operations comprising:
making, by an out-of-band component of the data processing system, an identification of a potential malicious attack on data stored in a storage device of hardware resources of the data processing system and by an entity hosted by the hardware resources via an in-band channel to the storage device; and
based on the identification:
performing, by a management controller and via at least one side band channel, a remediation process to attempt to mitigate impacts of the potential malicious attack on the data to facilitate continued provision of computer implemented services using the data.

14. The non-transitory machine-readable medium of claim 13, wherein the out-of-band component is one selected from a group consisting of the management controller and a controller of the storage device.

15. The non-transitory machine-readable medium of claim 14, wherein the controller of the storage device is adapted to load firmware during a boot of the data processing system, the firmware, once loaded, defining operation of the storage device during the making of the identification and the performing of the remediation process.

16. The non-transitory machine-readable medium of claim 13, wherein making the identification comprises:
monitoring, via a first sideband channel between the management controller and the storage device, input-output to the storage device for occurrences of predetermined input-output patterns; and
in an instance of the monitoring where the input-output matches one of the predetermined input-output patterns:
concluding that an occurrence of the potential malicious attack has occurred.

17. A system, comprising:
a processor; and
a memory coupled to the processor to store instructions, which when executed by the processor, cause operations for managing operation of a data processing system to be performed, the operations comprising:
making, by an out-of-band component of the data processing system, an identification of a potential malicious attack on data stored in a storage device of hardware resources of the data processing system and by an entity hosted by the hardware resources via an in-band channel to the storage device; and
based on the identification:
performing, by a management controller and via at least one side band channel, a remediation process to attempt to mitigate impacts of the potential malicious attack on the data to facilitate continued provision of computer implemented services using the data.

18. The system of claim 17, wherein the out-of-band component is one selected from a group consisting of the management controller and a controller of the storage device.

19. The system of claim 18, wherein the controller of the storage device is adapted to load firmware during a boot of the data processing system, the firmware, once loaded, defining operation of the storage device during the making of the identification and the performing of the remediation process.

20. The system of claim 17, wherein making the identification comprises:
monitoring, via a first sideband channel between the management controller and the storage device, input-output to the storage device for occurrences of predetermined input-output patterns; and
in an instance of the monitoring where the input-output matches one of the predetermined input-output patterns:
concluding that an occurrence of the potential malicious attack has occurred.
